(19) United States
(12) Patent Application Publication
(10) Pub. No.: US 2012/0111095 A1
(43) Pub. Date: May 10, 2012

(54) Heat Exchanger Integrity Testing

(76) Inventor: Paul Michael Sheehan, Limerick (IE)

(21) Appl. No.: 13/376,260

(22) PCT Filed: Jun. 4, 2010
(86) PCT No.: PCT/EP2010/057862

§ 371 Date: Jan. 13, 2012

(30) Foreign Application Priority Data
Jun. 5, 2009 (IE) S2009/0444

(51) Int. Cl. G01M 3/32

(52) U.S. Cl. 73/49.2

(57) ABSTRACT

The invention relates to the integrity testing of a heat exchanger numeral 1 having a high-pressure section 2 and the low-pressure section 3 by using valves 5, 6, 11 and 12 it is possible to isolate the heat exchanger from the larger system or plant in which it is incorporated. Having isolated each section from the larger system the high-pressure section 2 is pressurised while maintaining the low-pressure section 3 and at this rate pressure. Then after a preset time the pressure in the low-pressure section 3 is measured and if it has raised then there is a leak. Similarly measuring a pressure drop in the high-pressure section 2 will provide the same result.

### CROSS REFERENCE TO RELATED APPLICATIONS

The present application claims priority to PCT Application No. PCT/EP2010/057862 filed Jun. 4, 2010, which in turn claims priority to Irish Patent Application No. S2009/0444 filed Jun. 5, 2009, said applications being incorporated in their entirety herein by reference thereto.

### FEDERALLY SPONSORED RESEARCH AND DEVELOPMENT

None.

### BACKGROUND OF THE INVENTION

1. Field of the Invention

The present invention relates to a method of heat exchanger integrity testing and specifically to one having at least one low-pressure section and at least one high-pressure section when incorporated into a larger plant system.

2. Background

The terms “integrity” or “integrity testing” are used in this specification to refer to the identification of leaks between a high-pressure section and a low-pressure section of the heat exchanger. Strictly speaking the term covers other leaks, but as explained below these are not as important as the leaks which occur between a high-pressure section and a low-pressure section.

The purpose of the testing is to ensure that there are no leaks between the high-pressure sections and the low-pressure sections of a heat exchanger. While it goes without saying that there should be no leaks generally from either of the sections into the atmosphere and surrounding area, these are not nearly as important as cross-contamination of product when there is contamination of product in the low-pressure section by the introduction of liquid from the high-pressure section. This is a particular problem in the food industry where it can lead to product recall and general disturbance of the manufacturing process.

Plate heat exchangers are used extensively in industry and particularly in the food industry, for example, in pasteurising plants. A typical construction of such a plate heat exchanger comprises a plurality of gasketed stainless steel plates compressed into a frame. It is not uncommon to have of the order of between 10 and 600 plates in six separate sections. Accordingly, there are a large number of parts, pipe connections, valves and the like equipment in such heat exchangers. All of these are subject to deterioration and leakage.

The major problem with these plate heat exchangers is that in use, over a period of time, cracks form in some of the plates leading to the transfer of fluid from one section of the heat exchanger to another section. A further serious problem is that there may be a cracked plate with a small pinhole in it, which is the normal plate fault and that pinhole may be blocked by the liquid been treated such as milk, orange juice or indeed any liquid with suspended particles. That pinhole may not be cleared of the blockage during conventional testing procedures only to be cleared by the operation of the plate heat exchanger very shortly after recommissioning.

In most cases the procedure adopted is to effectively totally isolate the plate heat exchanger by removing all the connecting piping. The section to be tested it is usually purged and drained and then testing apparatus is connected to it. With this type of test the system liquid which is drained from the heat exchanger is usually lost and this can be expensive for example when the liquid is alcohol, glycol and other such liquids

Various test methods have been put forward to address this problem which have not heretofore been that successful. For example, U.S. Pat. No. 6,035,700 describes a method of testing a plate heat exchanger, using a separate gas, which is a very elaborate and time-consuming operation requiring the shutting down of the plate heat exchanger. The problem of using a gas as a test medium is that all of the liquid previously contained in that section of the plate heat exchanger has to be removed and this can be relatively difficult to achieve. Accordingly, due to liquid been retained in the plate heat exchanger the test is often not comprehensive One of the prior art methods discussed in this patent specification includes pressurising one side of the heat exchanger surface. This states that, for example, monitoring the pressure with no external leakage will indicate a cross-leakage to the heat transfer surface by way of a pressure change. The general principle has always been well-known however, what has not been appreciated is how to do it in an efficient manner. Heretofore, it has required the use of outside contractors and considerable downtime.

Because the testing is relatively time-consuming and expensive it is often only carried out three or four times a year with the consequent problems that may arise due to a leakage causing product contamination. There are certain additional problems that arise when a contractor is operating on the plant in the sense that often outside contaminants are introduced during the testing, whether simply from the manner in which the maintenance carried out or simply from the use of testing fluids. A further problem, as referred to already, is that very often the testing requires considerable disassembly of the plant and this together with the reassembly operation, in turn, often causes failure to occur some short time after the plant has been recommissioned.

A further problem with the use of contractors is that to a certain extent there is a conflict of interests. If the contractor identifies leaks then the contractor is commissioned to repair the plate heat exchanger. Presuming that the contractor does not find a leak and then a leak occurs relatively shortly thereafter this can cause considerable problems regarding the liability or otherwise of the contractor together with the problems of more machine downtime. In any case unfortunately, many of the staff of such contractors are relatively inexperienced and indeed badly trained.

What is required is a relatively simple test procedure or method which can be carried out by the plant operator at regular intervals with minimal disturbance of production.

### SUMMARY OF THE INVENTION

According to the invention there is provided a method of testing the integrity of a heat exchanger having at least one low-pressure section and at least one the high-pressure section when incorporated into a larger plant, comprising the steps, prior to operating the heat exchanger, of:
isolating each section from the system;
pressurising the high-pressure section to a pressure not less than the working pressure;
allowing the low-pressure section to be at atmospheric pressure; and
measuring the pressure in the high-pressure section after a preset time interval to determine whether there has been a drop in pressure and thus a leak between the high-pressure system section and the low-pressure system section.

By isolating the high-pressure system section and the low-pressure system section there is no dismantling of any of the heat exchanger connections and accordingly there will not be any air pockets in any of the high-pressure or low-pressure sections as the heat exchanger remains fully charged with liquid which ensures that all of the heat exchanger will be tested.

Essentially when the test is started, after automatically operating a series of valves and a pump or pumps to make sure both sides of the plates in each of the high-pressure section and the low-pressure section of, for example, a plate heat exchanger are fully charged with the liquid medium, the low pressure section is then pressurised, normally by water and not by a gas in contraflow to it is normal flow direction to a pressure of between 2 and 10 bar for a preset length of time, with no pressure exerted on the high-pressure section during this period. The high-pressure section may be pressurised but generally would be at atmospheric pressure and must be at least 2 bar below the pressure of the low-pressure section. The purpose of this is to clear any blockages there may be on the opposite side of the plates due to normal build-up of product residue after continuous use of such a plate heat exchanger during product processing. Then both sides of the high-pressure section and the low-pressure section are set to atmospheric pressure. Then the high-pressure section is pressurised to a test pressure usually of the order of between 2 and 10 bar, concentrating only on the pressure on the surface of the plates in this section and not on leaking gaskets, at atmospheric pressure in the low pressure section such that, the valves at the inlet and outlet of this section are closed isolating this low-pressure section from any increase in pressure except from a leaking plate. Therefore if there is a cracked or damaged plate arise in pressure in the low-pressure section will be detected.

This invention will be controlled by suitable control means such as a computer which will operate the tests either at each start up of the heat exchanger or other regular predetermined intervals of time.

### BRIEF DESCRIPTION OF THE DRAWINGS

The invention will be more clearly understood from the following description of some embodiments thereof, given by way of example only, with reference to the accompanying drawings.

FIG. 1 is a diagrammatic view of a plate heat exchanger illustrating the method of the present invention.

FIG. 2 is a view similar to FIG. 1 illustrating an alternative method of carrying out the present invention.

### DETAILED DESCRIPTION OF THE INVENTION

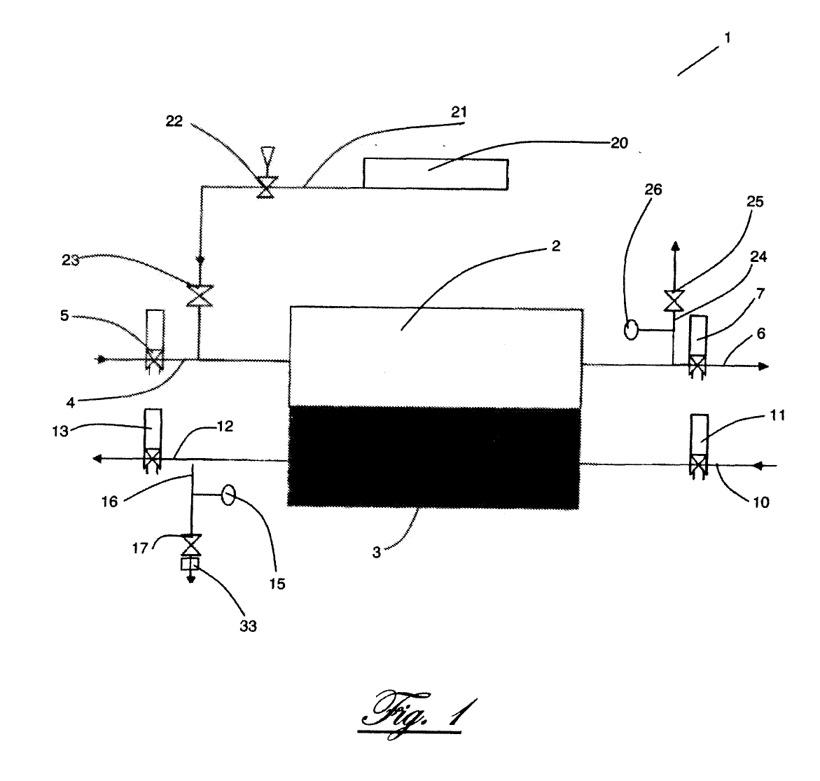

Referring to the drawings and initially to FIG. 1 thereof, there is illustrated in outline a plate heat exchanger, identified generally by the reference numeral 1, comprising a high pressure section 2 and a low-pressure section 3. The high pressure section 2 is connected to a product inlet pipe 4 having a shut-off valve 5 and feeds a product outlet pipe 6 having a shut-off valve 7. The low-pressure section 3 is fed by a water inlet pipe 10 having a shut-off valve 11 and in turn feeds a water outlet pipe 12 and shut-off valve 13. A pressure transmitter 15 is connected by a pipe 16 having a bleed-off valve 17 to the water outlet pipe 12. In the embodiment shown in FIG. 1, a flow meter 33 is connected to the bleed-off valve 17, although, it will be appreciated that the use of a flow meter is entirely optional.

An auxiliary pump 20 is connected by a pipe 21 through a pressure relief valve 22 and a further shut-off valve 23 to the product inlet pipe 4. The product outlet pipe 6 has a vent pipe 24 feeding a pressure relief valve 25. The vent pipe 24 also incorporates a pressure transmitter 26.

Various temperature and pressure sensing instruments are provided but are not illustrated for clarity.

In operation, the four valves 5, 7, 11 and 13 are closed. Accordingly, the plate heat exchanger is effectively isolated from the system. The low-pressure chamber or section 3 is pressurised with water to a pressure between 0 and 1 bar. Care is taken to ensure that the low-pressure section 3 is totally flooded and charged. The other chamber, namely, the high pressure section 2 is then pressurised to between 3 and 20 bar depending on the pressure decided to be used. This can generally be either the normal working pressure or some pressure in excess of that, such as its maximum operating pressure.

The high pressure section 2 and the low-pressure section 3 are monitored with both pressure and temperature being monitored to ensure that they are constant for a successful test. Presuming that there has been no increase or a change in temperature in the sections 2 and 3 and there is a pressure drop in the high pressure section 2 and a corresponding pressure rise in the low-pressure section 3 indicates that there has been a leak between the high pressure section 2 and the low-pressure section 3. Various other calculations may be made depending on what measurements had been carried out. For example, by knowing the volume of each chamber and the pressure drop, it is possible to estimate the size of the leak.

It is also envisaged, for example, that another method to enable the size of the leak to be estimated would be to establish the actual amount of liquid delivered out of the high pressure section into the low-pressure section by using the flow meter 33.

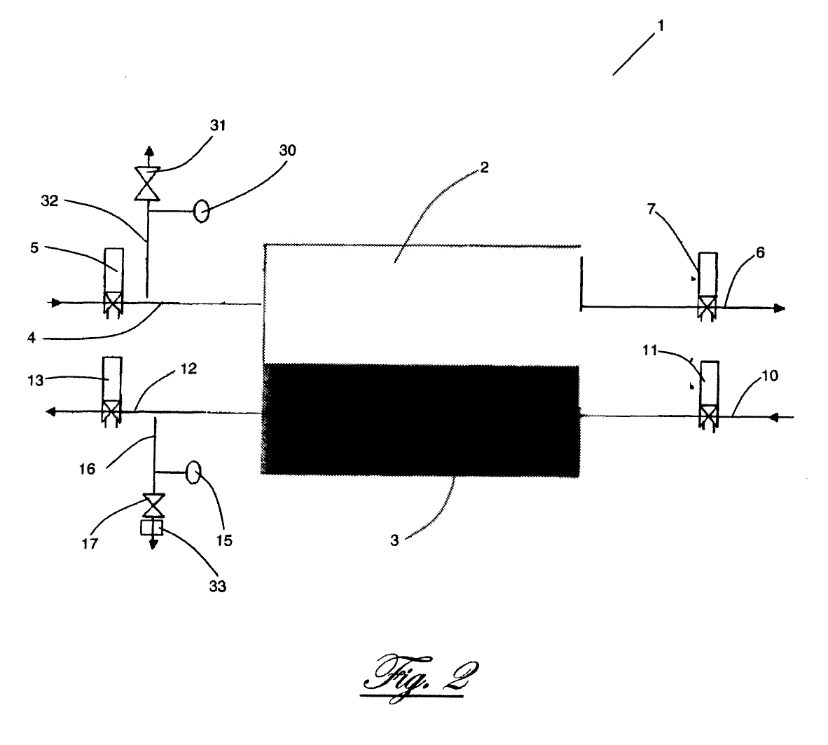

Referring now to FIG. 2, parts similar to those described with reference to FIG. 1 are identified by the same reference numerals. In the method illustrated by this drawing, an ancillary pump is not used as the product system pump is used instead, which pump is not illustrated. A pressure transmitter 30 and bleed-off valve 31 feed the product inlet pipe 4 via a pipe 32.

In operation, the valves 11 and 13 are closed and the valves 5 and 7 are opened. The bleed-off valve 17 is also opened. The product system pump is started which creates an unbalanced pressure between the two sections of the heat exchanger as the low-pressure system pump is not operated. The bleed-off valve 17 is kept open until the low-pressure section 3 is fully charged and it is then closed. As the high-pressure section or system pump is operated for the test time, usually about 30 minutes, there is constant pressure in the high pressure section 2. Again any leak will be easily identified.

It will be appreciated that the test systems described above, and any other variations thereof which are envisaged and deemed appropriate, may be carried out automatically at preset time intervals by the use of a suitable computer and relevant software. It is also envisaged that an appropriate time for carrying out such a test would be prior to re-starting the plant after a lay-off period.

To summarize the operation of the invention, when the test is started by use of a suitable computer controlled operations a series of valves and a pump or pumps are operated to ensure that both the high-pressure section and the low pressure section is fully charged by introducing water into both sections. Introducing water into the high-pressure section will marginally dilute the system liquid such as alcohol or glycol as they are simply refrigerant liquids it will have relatively little effect. Similar considerations apply to heating or pasteurising liquids. These sections are both at approximately atmospheric pressure when the low-pressure section is charged with water at a pressure of between 2 and 10 bar and in contraflow to the normal direction of flow of the liquid been treated. This will clear, hopefully, any blockage that there may be on the opposite side of the plates due to normal buildup of product residue after continuous use in production. Then both sections are set to atmospheric pressure and the high-pressure section is pressurised to a set pressure usually, between 2 and 10 bar concentrating only on the pressure on the surface of the plates and not on leaking gaskets. This is achieved as at atmospheric pressure in the low-pressure section the valves at inlet and outlet of this low-pressure section have isolated this low-pressure section from any increase in pressure except from a cracked plate. Accordingly, any rise in pressure in the low-pressure section indicates a leak.

It will be appreciated that one of the major advantages of the present invention is that the test can be carried out over relatively short intervals of time without the need to dismantle or in any way interfere with the smooth operation of the plate heat exchanger. Indeed, integrity testing may be carried out every day even more than once a day

Ideally, the plant is restarted at intervals which are determined by the risks and costs associated with failure. Generally, for example, in a food factory restarting once every day or every shift should be enough. For example, if on starting a shift a leak is detected it is usually a relatively simple task to identify when a product was made in the previous shift. Then by a process of elimination and testing batches at defined production time intervals contaminated product can easily be identified and either destroyed, or be processed again.

There are some considerable advantages of the present invention which will be apparent from the description above. Firstly, the plate heat exchanger is not taken out of production or isolated during the test. Secondly, none of the system liquids are lost but are used as part of the test protecting its integrity. Thirdly, there is no question of a conflict-of-interest in that the customer is doing their own test and it is only when a leak is determined that a contractor is employed. Fourthly, since none of the connections are being dismantled there is no question of introducing contaminants or indeed air which could cause air pockets and cause difficulties in the testing. The fact that generally water is introduced into the low-pressure section which is the section that contains the product to be treated does not it will be appreciated cause any difficulties.

While the present invention has been described with reference to plate heat exchangers as these are the most commonly used type of heat exchanger in many industries, it will be appreciated that the invention can be equally applied to any other construction of heat exchanger such as a shell or tube heat exchanger.

It will be appreciated that one of the major advantages of the present invention is that the operator of the plant has total control over integrity testing and accordingly control over maintenance planning. Indeed, in many instances as long as there is no leakage between the high-pressure section and the low-pressure section a considerable amount of leakage can be tolerated.

In this specification the terms “comprise” and “include” and any variations thereof for grammatical reasons are used interchangeably and are to be accorded the widest possible interpretation.

The invention is not limited to the embodiments and examples of the working of the invention hereinbefore described but may be varied in both construction and detail within the scope of the claims.

1. A method of testing the integrity of a heat exchanger having at least one low-pressure section and at least one high-pressure section when incorporated into a larger plant system, comprising the steps, prior to operating the heat exchanger, of:
isolating each section from the system;
pressurising the high pressure section to a pressure not less than the working pressure;
allowing the low-pressure section to be at atmospheric pressure; and
measuring the pressure in the high pressure section after a preset time interval to determine whether there has been a drop in pressure and thus a leak between the high-pressure system section and the low-pressure section

2. A method as claimed in claim 1 in which on isolating each section from the system the low-pressure section is first pressurised to a pressure of the order of 2 to 10 bar above that of the high-pressure section which is maintained at substantially atmospheric pressure.

3. A method as claimed in claim 2 in which pressurised fluid to elevate the pressure in the low-pressure section is introduced in contraflow to the normal flow of liquid through the low-pressure section.

4. A method as claimed in claim 2 in which the fluid is a liquid.

5. A method as claimed in claim 4 in which the liquid as water.

6. A method as claimed in claim 1 in which the temperature is monitored during the test to ensure that there is no variation in temperature, likely to cause an inaccurate measurement.

7. A method as claimed in claim 1 in which the high-pressure section is pressurised to a pressure in excess of the working pressure.

8. A method as claimed in claim 1 in which the increase in pressure in the low-pressure section is used as an indicator of the likely size of the leak.

9. A method as claimed in claim 1 in which a flushing liquid such as water is used to carry out the test and a separate pump is provided connected to the heat exchanger.

10. A method as claimed in claim 1 in which system fluid and system pumps are used to carry out the test.

11. A method as claimed in claim 1 in which the testing is carried out at preset time intervals to ensure that when a leak occurs not too much product is affected.

12. A method as claimed in claim 1 in which when a leak is detected the plant is shut down and the product inspected on the basis of examining a batch of product produced at fixed time intervals, commencing on the time when the test was last carried out, thereby isolating clearly product unaffected by the leak from that which needs to be destroyed or otherwise disposed of.

13. A method as claimed in claim 1 in which computerised control means are provided to operate suitably positioned valves to isolate the low-pressure section and the high-pressure section and pumps as required to pressurise the high-pressure section, on start-up, to provide the necessary method.

14. A method as claimed in claim 1 in which the following steps are carried out:
valves are operated to isolate the heat exchanger in the plant;
a pump is operated to ensure that both sections being tested are fully charged with liquid;
the low-pressure section is then pressurised by water in contraflow to its normal flow direction for a preset length of time while in maintaining the high pressure section at atmospheric pressure;
setting both the high-pressure section and the low pressure section to atmospheric pressure; and
pressurising the high-pressure section to carry out the necessary test.
